(19) United States
(12) Patent Application Publication
(10) Pub. No.: US 2024/0152893 A1
(43) Pub. Date: May 9, 2024

(54) SYSTEM AND METHOD FOR SALE OF DISCOUNTED NON-FUNGIBLE TOKENS

(71) Applicant: Shane Northrop, Fort Myers, FL (US)

(72) Inventor: Shane Northrop, Fort Myers, FL (US)

(21) Appl. No.: 17/979,994

(22) Filed: Nov. 3, 2022

(51) Int. Cl. G06Q 20/12; G06Q 30/0207

(52) U.S. Cl. CPC G06Q 20/123; G06Q 30/0239; G06Q 2220/00

(57) ABSTRACT

A computer-implement system and method for purchasing a large-scale discounted non-fungible token (NFT) is disclosed. The system comprises a processor and a memory unit to store a set of instructions executable by the processor, a database to store a plurality of data associated with the discounted NFT, and a user device to provide a digital marketplace that provides graphical user interface. Each NFT has a set of digital attributes and being cryptographically linked with certain goods or services. Further, the discounted NFT functions as a printable or scannable coupon or discount card, but protected from duplication to or theft cryptographically and via a ledger on a blockchain.

### BACKGROUND OF THE DISCLOSURE

### Technical Field

The disclosure relates to the field of non-interchangeable units of data stored on a blockchain, and more particularly, to a computer-implemented system executed in a network environment for selling discounted non-fungible tokens (“NFTs”).

The purchase or sale of NFTs is known in the art.

U.S. Pat. No. 10,853,797 describes cloud-based virtual wallet nfc apparatuses, methods and systems.

US 2022/025834 describes systems and methods for implementing blockchain-based content engagement platforms utilizing media wallets.

Currently, there is no NFT offered in conjunction with a large-scale discount program.

Therefore, a need exists to improve over the prior art and more particularly, for a system and method for selling and purchasing a discounted NFT on a large scale.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

In an aspect of the disclosure, a system for selling large scale discounted NFTS is disclosed.

In an aspect of the disclosure, a method for selling large-scaled discounted NFTs is disclosed.

Other systems, methods, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 shows a computer-implemented system executed in a network environment for selling/purchasing non-fungible tokens for a specific good or service.

FIG. 2 shows a method for selling/purchasing non-fungible tokens for a good or service in one aspect of the present disclosure.

### DETAILED DESCRIPTION

In an aspect of the disclosure, an NFT can be sold to individuals and businesses in a large-scaled discounted manner. The disclosed large-scale discounted NFT may be considered similar to a printed coupon or discount card, except that the disclosure relates to an NFT which is stored digitally, typically as a ledger entry on a blockchain and cannot be duplicated or plagiarized. In an aspect of the disclosure, companies or entities such as restaurants, entertainment, retail and other business industries such as service related businesses may offer discounts to anyone who holds the NFT. In return, the company offering the discounts may receive free promotion by being included as a list of companies who accept the NFT and would be included in the marketing of the NFT itself. This is similar to an individual purchasing a coupon book for a fixed price that offers various discounts with businesses, except that it would be in an immutable and secure digital format, such as an entry in a ledger of a blockchain.

The following detailed description refers to the accompanying drawings. Whenever possible, the same reference numbers are used in the drawings and the following description to refer to the same or similar elements. While disclosed aspects may be described, modifications, adaptations, and other implementations are possible. For example, substitutions, additions or modifications may be made to the elements illustrated in the drawings, and the methods described herein may be modified by substituting reordering or adding additional stages or components to the disclosed methods and devices. Accordingly, the following detailed description does not limit the disclosed aspects. Instead, the proper scope of the disclosed aspects is defined by the appended claims.

The elements in the Figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

In the description the term “server” refers to a general-purpose or special-purpose computer, generally including memory, input/output circuitry, and instruction processing logic along with interconnections such as one or more high-speed data buses connecting those components together. Many aspects of the disclosed techniques can be embodied as one or more server computers executing software. Similarly, a “client” herein is a computerized device (also including the above components and executing software) capable of receiving content from a network connection and decoding and rendering the content on a display or similar output device. So-called smartphones are specifically included within the definition of client as used herein.

For the purposes of the disclosure, though describing an example definition and not a limiting definition, a “blockchain” may be a type of central or decentralized digital ledger technology implemented in a computer program, storage medium containing instructions or a non-transitory signal and that consists of a growing list of records, called blocks, that are securely linked together using cryptography. Each block contains a cryptographic hash of the previous block, a timestamp, and transaction data (generally represented as a Merkle tree, where data nodes are represented by leafs). The timestamp proves that the transaction data existed when the block was created. Since each block contains information about the block previous to it, the blocks effectively form a chain, with each additional block linking to the ones before it. Blockchain transactions are intended to be irreversible in that, once they are recorded, the data in any given block cannot be altered retroactively without altering all subsequent blocks.

For the purposes of the disclosure, though describing an example definition and not a limiting definition, the term “non-fungible tokens” (NFTs) refers to digital instruments that will allow for data suppliers and data creators to take their data that would normally be tossed away after an inspection, surveillance or delivery for example, and either direct stream the data into the exchange database depository or repository and “purpose” the raw validated data and or “repurpose” the raw and or modeled verified data, to be used within the smart self-healing node centric mesh network of blockchain-based on a data exchange as data creators, producers and or suppliers start to develop photo images, videos and/or models, such as digital twin cities, that they can for example wish to sell, lease and/or license, data that can be provided to the buyer, user, acquirer, but where the creators, producers and or have decided to declare it as an original, unique, and one-of-a-kind digital data work product, that they will not reproduce, they will be able to do so via the NFT portion of the self-healing blockchain-based data exchange.

For the purposes of the disclosure, though describing an example definition and not a limiting definition, “digital currency” refers to currency, money, or money-like asset that is primarily managed, stored or exchanged on digital computer systems, especially over the internet. Types of digital currencies include cryptocurrency, virtual currency and central bank digital currency. Digital currency may be recorded on a distributed database on the internet, a centralized electronic computer database owned by a company or bank, within digital files or even on a stored-value card.

For the purposes of the disclosure, though describing an example definition and not a limiting definition, “cryptocurrency,” sometimes called crypto-currency or crypto, is any form of currency that exists digitally or virtually and uses cryptography to secure transactions. Cryptocurrencies don't have a central issuing or regulating authority, instead using a decentralized system to record transactions and issue new units.

Cryptocurrency is a digital payment system that does not rely on banks to verify transactions. It is a peer-to-peer system that can enable anyone anywhere to send and receive payments. Instead of being physical money carried around and exchanged in the real world, cryptocurrency payments exist purely as digital entries to an online database describing specific transactions. When you transfer cryptocurrency funds, the transactions are recorded in a public ledger. Cryptocurrency is stored in digital wallets.

For the purposes of the disclosure, though describing an example definition and not a limiting definition, a “digital wallet,” also known as an e-wallet, is an electronic device, online service, or software program that allows one party to make electronic transactions with another party bartering digital currency units for goods and services. This can include purchasing items either online such as on Web3 and Mainnet 2.0 or at the point of sale in a brick-and-mortar store, using either mobile payment (on a smartphone or other mobile device) or (for online buying only) using a laptop or other personal computer. You can use the touchless wand capabilities to make payments as well through your mobile device's application. Money can be deposited in the digital wallet prior to any transactions or, in other cases, an individual's bank account can be linked to the digital wallet. Users might also have their driver's license, health card, loyalty card(s) and other ID documents stored within the wallet. The credentials can be passed to a merchant's terminal wirelessly via near field communication (NFC).

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

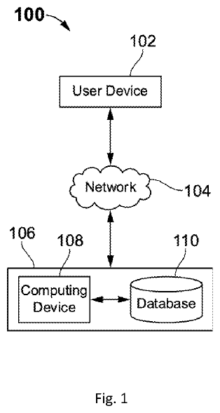

Referring now to the Figures, FIG. 1 shows a computer-implemented system executed in a network environment 100 for selling a large-scale discounted non-fungible token (NFT).

In one aspect, the network environment 100 comprises one or more user devices 102 and an NFT management system 106. Each user device is associated with a user. In one aspect, the user device 102 is configured to provide a digital marketplace that provides a graphical user interface. In one aspect, the graphical user interface allows the user to transact for one or more items of the set of items from the user device 102. In one aspect, the user device 102 enables the user to access one or more services provided by the system. In one aspect, the user device 102 communicates with the NFT management system 106 via a communication network 104. In one aspect, the user device 102 is enabled to access the NFT management system 106 via network 104. In one aspect, the user device 102 is at least any one of a smartphone, a mobile phone, a tablet, a laptop, a smart watch, a smart wearable device, a desktop, and/or other suitable hand-held electronic communication devices. In one aspect, the user device 102 comprises a storage medium in communication with the network 104 to access the NFT management system 106. In an aspect, the network 104 could be Wi-Fi, WiMAX, wireless local area network (WLAN), satellite networks, cellular networks, private networks, and the like.

In one aspect, the NFT management system 106 comprises a server or computing device 108 and one or more databases 110 in communication with the computing device 108. In one aspect, the computing device 108 may be a cloud server. In one aspect, the computing device 108 may be operated as a single computer. In some aspects, the computer may be a touchscreen and/or non-touchscreen and adopted to run on any type of OS, such as iOS™, Windows™, Android™, Unix™, Linux™, and/or others. In one aspect, the plurality of computers is in communication with each other, via networks. Such communication is established via any one of an application software, a mobile application, a web application, a desktop application, a browser, an OS, and/or any combination thereof.

In one aspect, the database 110 is in communication with the computing device 108 via the network 104. In one aspect, the database 110 is accessible by the computing device 108. In another aspect, the database 110 is integrated into the computing device 108 or separate from it. In some aspects, the database 110 resides in a connected server, distributed database or a cloud computing service. Regardless of location, the database 110 comprises a memory to store and organize certain data for use by the computing device 108. In one aspect, the database 110 is in communication with at least one processor via a communication network configured to store a plurality of data associated with the large-scale NFT, according to the disclosure. In an aspect of the disclosure, the database 110 may store or host a blockchain or a component of a blockchain, where the discounted NFTs according to the disclosure may be recorded on one or more entries in a ledger stored on the blockchain.

In one aspect, the computing device 108 comprises at least one processor and computer-readable medium or memory unit operatively coupled to the processor. The memory unit stores a set of instructions executable by the processor configured to sell non-fungible tokens to the customers. The memory unit could be RAM, ROM (including EPROM, EEPROM, PROM). In one aspect, the user devices 102 are configured to access the services provided by the computing device 108 via the network 104. In one aspect, the computing device 108 is configured to provide a communication platform for purchasing NFTs by the customers. In one aspect, the communication network is associated with the memory configured to receive the large-scale discounted NFT, according to the disclosure.

In one aspect, the system performs sells NFTs related to a large-scale discount program. The disclosed large-scale discounted NFT may be considered similar to a printed coupon or discount card, except that the disclosure relates to an NFT which is stored digitally, typically as a ledger entry on a blockchain and cannot be duplicated or plagiarized. In an aspect of the disclosure, companies or entities such as restaurants, entertainment, retail and other business industries such as service-related businesses may offer discounts to anyone who holds the NFT. In return, the company offering the discounts may receive free promotion by being included as a list of companies who accept the NFT and would be included in the marketing of the NFT itself. This is similar to an individual purchasing a coupon book for a fixed price that offers various discounts with businesses, except that it would be in an immutable and secure digital format, such as an entry in a ledger of a blockchain.

Participation by particular entities in the discount campaign may result in the entity providing and the user receiving additional entity information includes advertising information, additional discount information related to the service or the good, or membership information related to discount campaigns offered by the entity.

In one aspect of the disclosure, the purchase of a large-scaled discounted NFT may be made using cryptocurrency, digital assets, and other traditional forms of payment including credit cards, debit cards, Apple/Google Pay, etc. In one aspect, the system directs the customer or user, or purchaser toward an NFT marketplace via a QR code or an inaudible tone at a live event. In one aspect, the QR code or inaudible tone may be received in person, during televised broadcasts, websites, and apps. In one aspect, the customer purchases or sells the discounted NFT for use of purchase of goods or services, much like a printed coupon or discount card, but immutable and protected from duplication or theft. Each NFT has a set of digital attributes and being cryptographically linked with a discount for a certain good or service or may be used broadly for other classes of goods or services.

In one aspect, the system further comprises a blockchain configured to store the discounted NFT received over the communication network. In one aspect, the system further allows the user to burn (trade-in) NFTs in exchange for an upgrade or swap for NFTs for other goods or services classes. In one aspect, the burning NFTs permanently remove the token stored on a blockchain from circulation. The burning NFTs eliminates unsold or problematic inventory from an NFT drop. In one aspect, the burning NFTs engage users through upgrades that replace an original NFT with a new NFT.

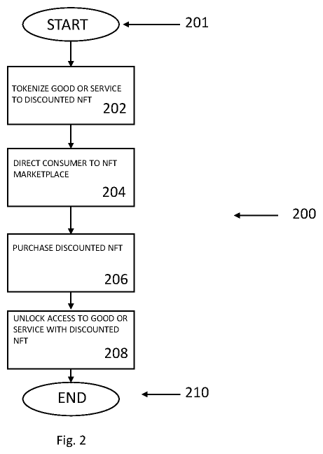

FIG. 2 shows a flow chart 200 of acts taken for purchasing a large-scale discounted NFT of a specific event or item, according to one aspect. In one aspect, the method 200 includes a system comprising at least one processor and a memory unit operatively connected to the at least one processor configured to store a set of instructions executable by the at least one processor, a database in communication with at least one processor via a communication network configured to store a plurality of data associated with the discounted NFT, and a user device associated with a user-configured to provide a digital marketplace that provides a graphical user interface, where the graphical user interface allows the user to transact for one or more items of the set of items from the user device. At act 201, these components and related software are provided to a user. the process includes the following acts.

At act 202, the tokenization of a coupon/discount card is performed into a NFT related to the specific good or service. In one aspect, the NFT acts as a discount card or coupon for use with certain goods or services.

At act 204, a customer, user, or purchaser is directed towards the NFT marketplace via a direction prompt such as a QR code, weblink or an inaudible tone. In one aspect, the QR code, weblink or inaudible tone may be received in person, during televised broadcasts and streaming media feeds, websites, and/or apps.

At act 206, the discounted NFT is purchased or sold to provide access to a certain good or service associated with the discounted NFT. In one aspect, each discounted NFT has a set of digital attributes and being cryptographically linked with a respective good or service. In one aspect, the purchase may be made using cryptocurrency, digital assets, and other traditional forms of payment including credit cards, debit cards, Apple/Google Pay, etc. The assets available for use may be stored in a digital wallet associated with a particular user, such as a person, business or other entity.

At act 208, the access related to the specific discounted good or service is unlocked. In one aspect, the NFT directly unlocks the access related to the good or service.

At act 210, the process may terminate, or may repeat as needed when the user has completed the transaction and the transaction is recorded in a ledger on a blockchain associated with the discounted NFT.

The sequence diagram in FIG. 2 may be encoded in a signal bearing medium, a computer readable medium such as a memory, programmed within a device such as one or more integrated circuits, or processed by a controller or a computer. If the methods are performed by software, the software may reside in a memory resident to or interfaced to the any type of non-volatile or volatile memory interfaced or resident to the memory incorporated in the components in the network environment 100. Such memory may include an ordered listing of executable instructions for implementing logical functions. A logical function may be implemented through digital circuitry, through source code, through analog circuitry, or through an analog source such through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various aspects of the disclosure have been described, including the best mode known to the inventors for carrying out the disclosure, it will be apparent to those of ordinary skill in the art that many more aspects and implementations are possible within the scope of the disclosure. Accordingly, the disclosure is not to be restricted except in light of the attached claims and their equivalents.

What is claimed is:

1. A computer-implemented system executed in a network environment for purchasing a discounted non-fungible token (NFT) for use in commerce of a good or service, comprising:
at least one processor and a memory unit operatively connected to the at least one processor configured to store a set of instructions executable by the at least one processor;
one or more databases in communication with the at least one processor via a communication network configured to store a plurality of data associated with the discounted NFT, where the communication network is associated with the memory configured to receive the discounted NFT; and
a user device associated with a user configured to provide an NFT marketplace that provides a graphical user interface, where the graphical user interface allows the user to transact for one or more items of the set of items from the user device,
where the processor is configured to:
perform tokenization of a good or service into the discounted NFT related to the good or the service;
direct a customer or user or purchaser towards an NFT marketplace relating to at least the discounted NFT via a direction prompt;
purchase or sell the NFT to provide access to the good or service, and unlock the access related to the good or the service.

2. The system of claim 1, further comprising a blockchain configured to store the discounted NFT received over the communication network.

3. The system of claim 1, where each NFT comprises a set of digital attributes and being cryptographically linked with a respective good or respective service.

4. The system of claim 1, where an entity offering a discount related to the discounted NFT receives free promotion by being included as a list of entities who accept the discounted NFT.

5. The system of claim 4, where the entity offering the discount would be included in the marketing of the discounted NFT.

6. The system of claim 1, where the direction prompt is received in person, during televised broadcasts, streaming media over the network environment, websites and/or apps.

7. The system of claim 1, where the NFT is configured to directly allow access related to the good or service.

8. A method for purchasing a discounted NFT of a good or service using a computer-implemented system comprising at least one processor and a memory unit operatively connected to at least one processor configured to store a set of instructions executable by at least one processor, a database in communication with at least one processor via a communication network configured to store a plurality of data associated with the discounted NFT, and a user device associated with a user configured to provide an NFT marketplace that provides a graphical user interface, where the graphical user interface allows the user to transact for one or more items of the set of items from the user device, where the method comprises:
performing tokenization of a good or service into the discounted NFT related to the good or the service;
directing a customer or user or purchaser towards an NFT marketplace via a direction prompt; and
purchasing or selling the discounted NFT to provide access to the good or service, where each NFT has a set of digital attributes and being cryptographically linked with the good or the service; and
unlocking the access related to the good or service.

9. The method of claim 8, further comprising storing the discounted NFT received over the communication network on a blockchain.

10. The method of claim 8, where the discounted NFT is configured to directly unlock the access to the good or service.

11. The method of claim 8, where an entity offering a discount related to the discounted NFT receives free promotion by being included as a list of entities who accept the discounted NFT.

12. The method of claim 11, where the entity offering the discount would be included in the marketing of the discounted NFT.

13. The method of claim 8, where directing the customer or the user or the purchaser towards the NFT marketplace via the direction prompt comprises providing the direction prompt in person, during televised broadcasts, streaming media over the network environment, websites and/or apps.

14. A graphical user interface for facilitating the sale of a discounted NFT, where the graphical user interface allows a user to transact for one or more items of the set of items from the user device,
where the graphical user interface is configured to allow the user to:
initiate a tokenization of a good or service into the discounted NFT related to the good or the service;
access an NFT marketplace relating to at least the discounted NFT via a direction prompt;
purchase or sell the discounted NFT to provide access to the good or service, and unlock the access related to the good or the service.

15. The graphical user interface of claim 14, where the direction prompt is received via the graphical user interface in person, during televised broadcasts, streaming media over the network environment, websites and/or apps.

16. The graphical user interface of claim 14, where the graphical user interface allows direct access related to the good or service.

17. The graphical user interface of claim 14, where an entity offering a discount related to the discounted NFT receives free promotion by being included as a list of entities who accept the discounted NFT.

18. The graphical user interface of claim 17, where the entity offering the discount would be included in the marketing of the discounted NFT.

19. The graphical user interface of claim 17, where the graphical user interface is configured to present additional entity information to the user.

20. The graphical user interface of claim 19, where the additional entity information includes advertising information, additional discount information related to the service or the good, or membership information related to discount campaigns offered by the entity.
